(19) United States
(12) Patent Application Publication
(10) Pub. No.: US 2006/0100340 A1
(43) Pub. Date: May 11, 2006

(54) Polymer and water repellent compositions for wood product dimensional stability

(76) Inventors: Howard Gao, East Amherst, NY (US); Jun Zhang, Getzville, NY (US); Robert M. Leach, Grand Island, NY (US)

Correspondence Address: HODGSON RUSS LLP, ONE M & T PLAZA, SUITE 2000, BUFFALO, NY, 14203-2391, US

(21) Appl. No.: 11/268,988

(22) Filed: Nov. 7, 2005

Related U.S. Application Data
(60) Provisional application No. 60/625,643, filed on Nov. 5, 2004.

(51) Int. Cl. C08L 91/06; C04B 41/50; C09J 11/06; C09G 1/10

(52) U.S. Cl. 524/475; 106/271; 106/287.28; 106/287.1

(57) ABSTRACT

A composition for improving the dimensional stability of wood and other cellulosic materials is provided. The composition comprises a polymer which is present in dispersion, emulsion, or solvated form; and/or a water repellent. Also provided is a method for improving the dimensional stability of wood and other cellulosic substrates which comprises treating the substrate with the composition such that the polymer forms a film on the surface and inner structures of the wood.

This application claims priority to U.S. provisional application no. 60/625,643, filed on Nov. 5, 2004, the disclosure of which is incorporated herein by reference.

### BACKGROUND OF THE INVENTION

The main components of wood are cellulose, hemicellulose and lignin. The cellulose and hemicellulose contain hydrophilic structures which are mainly hydroxyl groups. The hydroxyl groups have the ability to interact with water molecules to form hydrogen bonds. Wood is capable of absorbing as much as 100% of its weight in water which causes the wood to swell. Water loss through evaporation results in wood shrinking. This natural water absorption/evaporation process is non-uniform which creates internal stresses in the wood. These internal stresses cause the wood to split and warp.

There is an increasing interest in improving the dimensional stability of wood. The degree of swelling and shrinking exhibited by wood upon exposure to water and subsequent drying can be eliminated or minimized by reducing the affinity of the wood for water. This can be accomplished by reacting the hydroxyl groups in the cell wall components of wood with various products to reduce the hydrophilicity of wood. This process gives a chemically modified wood. Chemical modification methods, an example of such being acetylation, generally act by increasing the volume of the dry cell wall, thus increasing wood fiber bulk and decreasing wood shrinkage. Another approach to wood stabilization is to physically deposit an external or internal coating to prevent the hydroxyl groups from absorbing water thus reducing wood. The deposition of bulking agents can be achieved by impregnating non-reactive bulking agents into the wood or by impregnating monomers into the wood followed by polymerization of the monomers within the wood. Bulking agents known to those skilled in the art include polyethylene glycol (PEG), phenol, resorcinol, melamine and urea-formaldehydes, phenol furfural, furfuryl-analine and furfuryl alcohol and various vinyl resins such as polystyrene, polymethyl methacrylate, polyacrylonitrile, polyvinyl chloride. However, in most cases significant improvement in dimensional stability can only be achieved when polymer content of the wood (retention) is at least 30% by weight.

There are currently three commercial processes available to afford dimensional stability to wood. They are acetylation, furfurylation and thermal treatment. Acetylation gives an anti-swelling efficiency (ASE) of 75% with a weight increase of 26% to 28% for softwoods. The Brown and Black technologies of Wood Polymer Technologies AS (WPT) are based on furfurylation of wood which provided an ASE of 60% with a weight gain of 30%. Both approaches involved chemical reactions and require heating for reactions to occur. The heating requirement and the high retentions associated with these methods make the process expensive, and thus less commercially feasible. Additionally, thermal treatment can result in a decrease in mechanical strength.

It is an object of this invention to provide water-borne or water-based dimensional stabilization agents which give sufficient water repellency to wood and other cellulose-based materials for long term outdoor performance. Another object is to improve the dimensional stability of the above materials, while minimizing the percent retention of treatment chemicals. This need is solved by the subject matter disclosed herein.

### SUMMARY OF THE INVENTION

This invention relates to water-based compositions comprising a polymer component and/or a water repellant component. The polymer component and the water repellant component can be present as emulsion, dispersion, solution or combinations thereof. The composition can be prepared as a water based concentrate which can be conveniently stored for later use with or without dilution with water. The treatment with the composition improves the anti-swelling properties of the wood and other cellulosic materials thus providing dimensional stability. The composition, either in concentrated or diluted form, may also contain biocides to provide mold, fungal, bacterial, and insect resistance.

The polymers used in the present compositions can be polyurethane, polyester, polyamide, epoxy, acrylic polymers, vinyl polymers including polymers made from ethylenically unsaturated monomers such as polybutene, oligomers of above chemistries and natural polymers. The water repellent can be a wax dispersion such as paraffin wax, polyethylene wax, carnauba wax and microcrystalline wax, paraffin wax-polybutene, or silicone and fluoro-compounds.

The polymer emulsion or dispersion and water repellent emulsion or dispersion can be anionic, cationic or non-ionic in nature, and the component particles or droplets generally have a particle size ranging from 0.001 microns to 25.0 microns, and preferably between 0.001-1.0 microns.

The compositions of this invention demonstrate synergistic interactions between the polymer and water repellent components to provide improved anti-swelling efficiency (ASE) and water exclusion efficiency (WEE).

The above advantages can be imparted to wood and other cellulosic materials at retentions as low as 3.5% weight gain. The compositions of the present invention can be applied by coating, dipping, brushing, spraying, and pressure impregnation. The compositions of this invention have the ability to form a water repellent film on the surface and internal structure of the wood. While not intending to be bound by any particular theory, it is considered that the film reduces the rates of water evaporation and water adsorption on and in substrates which have been treated with the composition. As a result, the moisture gradient between the surface and internal components of the substrate is reduced, giving a decrease in internal stresses and thus improving dimensional stability of the treated substrate.

### BRIEF DESCRIPTION OF THE FIGURES

FIG. 1 is a plot of anti-swelling efficiency (ASE) of southern yellow pine wafers treated with acrylic polymer emulsion and water repellent as a function of chemical concentration. The ASE test was conducted following the procedure described in AWPA Standard E4-78 “Standard Method of Testing Water Repellency of Pressure Treated Wood”.

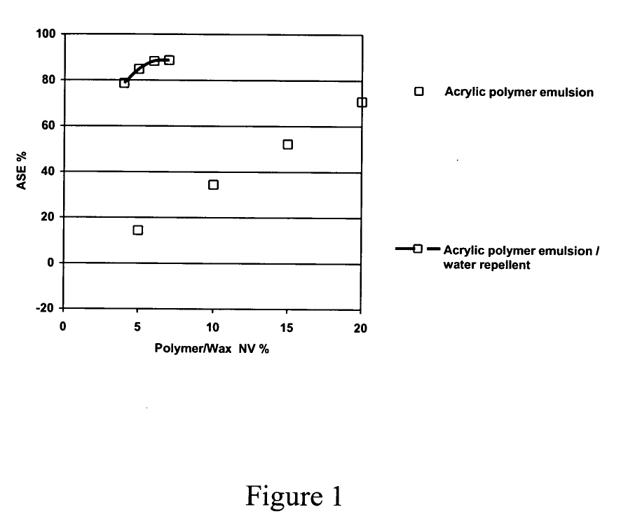

FIG. 2 is a plot of water exclusion efficiency (WEE) of southern yellow pine wafers treated with acrylic polymer emulsion and water repellent as a function of chemical concentration. The WEE test was conducted following the procedure described in AWPA Standard E4-78 “Standard Method of Testing Water Repellency of Pressure Treated Wood”.

FIG. 3 depicts Coniferous Wood Anatomy.

FIG. 4 depicts the border pit structure for coniferous woods.

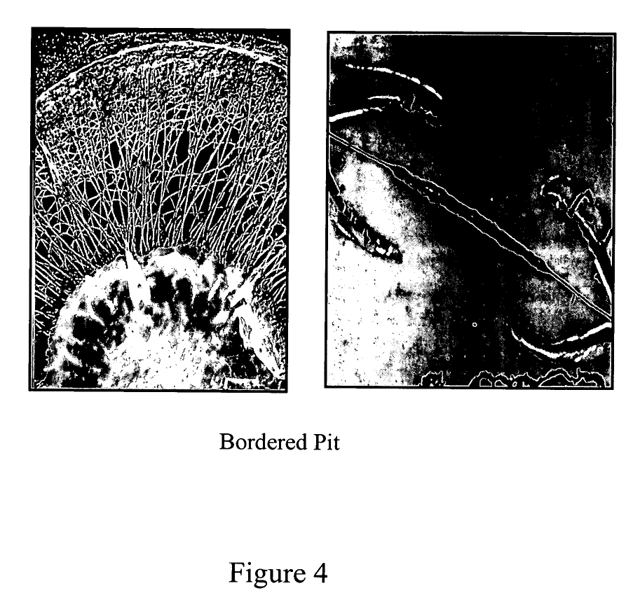

FIG. 5 depicts control wood panels after outdoor exposure for 3 months. The stain and checks were observed.

FIG. 6 depicts southern yellow pine wood panels treated with acrylic polymer emulsion/water repellent after outdoor exposure for 3 months. The panels were very clean and check free.

### DETAILED DESCRIPTION

The term “cellulosic materials” includes wood paper, cotton, textile and other products made of cellulose fibers. The term “wood” described in this invention includes all forms of wood, such as solid wood, wood composite materials, e.g. wood fiberboard, chipboard, particleboard, and all forms of products made from wood or wood composite materials, e.g. Mill frames, decking, siding, siding cladding, roof shingles and utility poles.

The term “dimensional stability” or dimensional stabilization” refers to the ability of wood to maintain its structural integrity, particularly upon exposure to environmental moisture. Generally an increase in structural integrity is marked by a reduction or elimination of one or more of the following when treated wood is exposed to water: checking, splitting, warping, grain raising, and roughness.

The term “emulsion” is understood to mean an oil-in-water emulsion in which a component is dispersed in the form of droplets in a continuous aqueous phase. If necessary, the emulsion can be stabilized by a stabilizer or emulsifier or the like. The term “dispersion” is understood to mean an aqueous dispersion in which a component is present in the form of particles in an aqueous phase. If necessary, the dispersion can be stabilized by a conventional dispersing system known to those skilled in the art.

The designation “water repellent”, unless specifically stated otherwise, refers to compounds known to those of skill in the art to provide water beading properties, reduced water absorption and/or swelling to the substrate when exposed to aqueous conditions. Unless stated otherwise, such as in the examples, all amounts and numbers used in this specification are intended to be interpreted as modified by the term ‘about’. Likewise, all compounds or elements identified in this specification, unless stated otherwise, are intended to be non-limiting and representative of other compounds or elements generally considered by those skilled in the art as being within the same family of compounds or elements.

Disclosed herein are compositions comprising a polymer component and/or a water repellant component. The polymer component and the water repellant component can be present as emulsions, dispersions, solutions or combinations thereof. The polymer component alone can provide water repellency and dimensional stability. However, the present invention optionally/alternatively includes one or more water repellents.

The compositions can be prepared as a concentrate, if desired, and diluted with water to a convenient concentration which can be applied to wood to give the desired dimensional stability performance.

The polymer emulsions or dispersions are composed of discrete polymer droplets or particles, stabilized, if necessary, by appropriate emulsifying agents or dispersants. After application of these particles to a substrate, particularly wood, the particles and/or droplets fuse together to form a continuous film if the substrate is at a temperature which is above the minimum film-forming temperature of the polymer. It may be necessary to raise the temperature of the wood in order for the film to form. Typically, film formation occurs as water evaporates. After application of the composition, the wood may be subjected to a drying step. The drying step can be performed with a kiln or other suitable drying means, typically at a time in the range of from one hour to 5 days at a temperature which is typically in the range of from 40 to 200° C. If the wood is already at a temperature which is greater than the minimum film formation temperature of the polymer droplets and/or particles, it is not necessary to raise the temperature of the wood in order to cause film formation. Typically, droplets have much lower minimum film formation temperatures than particles.

The film is formed upon the surface of the wood as well as in the interstices of the wood. By “interstices” is meant the internal structures of the wood. These structures are generally in the vicinity of the droplets or particles upon the penetration of these particles and droplets into the interior of the wood. The structures include the inside and outside of the wood lumens, tracheids, etc. Polymer which is solvated in the composition will form a film upon the evaporation of the water, regardless of wood temperature.

Once formed, the film is water insoluble and is not affected by rain. Combination of the polymer emulsion or dispersion with water repellents, such as for example, a paraffin wax dispersion, results in the polymer acting as a binder, embedding the paraffin particles in the polymer film. It is thought that the hydrophobicity of the paraffin wax enhances polymer water repellency whereas the polymer retains the wax particles in place for long term performance. If minimum film formation temperature of the polymer is higher than the melting point of paraffin wax, the wax may melt. However, the polymer film will, in most cases, still be effective. If desired, a polymer which exhibits UV resistance can be selected, and therefore, the combined polymer/water repellent system can provide long term outdoor performance.

As is known in the art, the minimum film formation temperature of the polymer is a function not only of polymer identity (length, monomer content, etc.), but also of particle size, with smaller particles generally having a lower minimum film formation temperature. Coalescent additives can also be added to affect the minimum film formation temperature.

The polymer component can be made of synthetic polymers (by means of condensation polymerization or radical polymerization), polymers of natural origin, and mixtures thereof.

Condensation polymers may include polyurethanes, polyesters, polyesteramides, fatty-chain polyester, polyamides and epoxyester resins.

The polyurethanes may be chosen from anionic, cationic, nonionic or amphoteric polyurethanes, acrylic polyurethanes, polyurethane-polyvinylpyrrolidones, polyester-polyurethanes, polyether-polyurethanes, polyureas, polyurea-polyurethanes and mixtures thereof.

The polyurethane can be, for example, an aliphatic, cycloaliphatic or aromatic polyurethane, polyurea/urethane or polyurea copolymer containing, alone or as a mixture: one sequence of linear or branched aliphatic and/or cycloaliphatic and/or aromatic polyester origin, and/or one sequence of aliphatic and/or cycloaliphatic and/or aromatic polyether origin.

The polyurethanes can also be obtained from branched or unbranched polyesters, or from alkyds containing labile hydrogens which are modified by reaction with a diisocyanate and a difunctional (for example dihydro, diamino or hydroxyamino) organic compound, in addition containing either a carboxylic acid or carboxylate group, or a sulphonic acid or sulphonate group, or alternatively a tertiary amine group or a quaternary ammonium group. Commercially available polyurethane dispersions include Sancure 815 and Cur 21.

The polyesters can be obtained, as well known, by polycondensation of dicarboxylic acids with polyols, in particular diols.

The dicarboxylic acid can be aliphatic, alicyclic, or aromatic. Examples of such acids, which may be mentioned, are: oxalic acid, malonic acid, dimethylmalonic acid, succinic acid, glutaric acid, adipic acid, pimelic acid, 2,2-dimethylglutaric acid, azelaic acid, suberic acid, sebacic acid, fumaric acid, maleic acid, itaconic acid, phthalic acid, dodecanedioic acid, 1,3-cyclohexanedicarboxylic acid, 1,4-cyclohexanedicarboxylic acid, isophthalic acid, terephthalic acid, 2,5-norbornanedicarboxylic acid, diglycolic acid, thiodipropionic acid, 2,5-naphthalenedicarboxylic acid, and 2,6-naphthalenedicarboxylic acid. One or more different dicarboxylic acid monomers can be used to form the polymer. Among these monomers, the ones preferably chosen are phthalic acid, isophthalic acid, and terephthalic acid.

The diol can be selected from aliphatic, alicyclic, and aromatic diols. The diol preferably used is one chosen from: ethylene glycol, diethylene glycol, triethylene glycol, 1,3-propanediol, cyclohexanedimethanol, and 1,4-butanediol. Other polyols, which can be used include glycerol, pentaerythritol, sorbitol, and trimethylolpropane.

The polyesteramides can be obtained in a similar manner to that for the polyesters, by polycondensation of diacids with diamines or amino alcohols. Diamines which can be used are ethylenediamine, hexamethylenediamine and meta- or para-phenylenediamine. An amino alcohol which can be used is monoethanolamine.

All polycondensations described herein, including those described below, can be conducted such that the following monomers are also incorporated into the polymer: monomers bearing an anionic group such as dimethylolpropionic acid, trimellitic acid or a derivative such as trimellitic anhydride, the sodium salt of pentanediol-3-sulphonic acid and the sodium salt of 1,3-benzenedicarboxylic-5-sulphonic acid.

The fatty-chain polyesters can be obtained using fatty-chain diols in the polycondensation.

The epoxyester resins can be obtained by polycondensation of fatty acids with a condensate containing α,ω-diepoxy ends.

Radical polymers can be used in the compositions of the present invention. Non-limiting examples of particular radical polymers which can be used are acrylic and/or vinyl polymers or copolymers. These polymers can result from the polymerization of ethylenically unsaturated monomers containing at least one acid group and/or esters of these acidic monomers and/or amides of these acidic monomers.

Monomers bearing an acid group such as α,β-ethylenic unsaturated carboxylic acids such as acrylic acid, methacrylic acid, crotonic acid, maleic acid, itaconic acid and 2-acrylamido-2-methylpropane-sulphonic acid can be used in the radical polymerization.

Acrylic polymers resulting from the copolymerization of monomers chosen from acrylic acid or methacrylic acid and the esters and/or amides of acrylic acid or of methacrylic acid, can be used. Examples of ester-type monomers are alkyl, in particular C₁-C₂₀ alkyl, methacrylates such as methyl methacrylate, ethyl methacrylate, butyl methacrylate, isobutyl methacrylate, 2-ethylhexyl methacrylate and lauryl methacrylate, or acrylates such as ethyl acrylate, butyl acrylate and hexyl acrylate. The alkyl group of the esters in this invention can also be either fluorinated or perfluorinated. Examples of amide-type monomers which can be mentioned-are N-tert-butyl acrylamide and N-tert-octylacrylamide.

Acrylic polymers that can be used include those obtained by copolymerization of ethylenically unsaturated monomers containing hydrophilic groups of nonionic nature, such as hydroxyethyl acrylate, 2-hydroxypropyl acrylate, hydroxyethyl methacrylate or 2-hydroxypropyl methacrylate. Examples of commerciallty available acrylic polymer emulsion examples are Lucidene 605, Joncryl 624, Zinchem 295, G-cryl 2000, Vancryl 960 and Carboset 1086.

The vinyl polymers can result from the homopolymerization or copolymerization of monomers chosen from vinyl esters, styrene, α-methylstyrene, acrylonitrile, vinyl chloride, and vinylidene chloride. Examples of vinyl esters which can be mentioned are vinyl acetate, vinyl neodecanoate, vinyl pivalate, vinyl benzoate and vinyl tert-butyl benzoate. In particular, these monomers can be polymerized with acidic monomers and/or their esters and/or their amides, such as those mentioned above. Acrylic/silicone copolymers or nitrocellulose/acrylic copolymers can also be used.

The ethylenically unsaturated monomers, such as, ethylene, propylene, butylenes, butadiene, isoprene and cyclopentadiene can also be incorporated into the polymer.

Optionally, oligomers composed of above monomers can be used to further enhance the performances of the formulations described in this invention. The term “oligomer” is defined as a molecule composed of a small number of linked monomer units; i.e.: a short polymer; compounds called oligomers have less than one hundred monomer units and usually less than thirty. These oligomers can be emulsified separately from the rest of the composition and then added. They can be prepared by emulsion polymerization.

The monomers mentioned above do not limit the invention, and it is possible to use other monomers known to those skilled in the art, especially acrylic and vinyl monomers, to make the polymers or oligomers mentioned above.

The polymers of natural origin, which are optionally organically modified, can be chosen from shellac resin, sandarac gum, dammar resins, elemi gums, copal resins, cellulose derivatives and mixtures thereof.

The polymers resulting from the radical polymerization of one or more radical monomers inside and/or partially at the surface of pre-existing particles of at least one polymer chosen from the group consisting of polyurethanes, polyureas, polyesters, polyesteramides and/or alkyds may also be used. These polymers are generally known as “hybrid polymers.”

The polymers which can be used in the present invention generally have a minimum film formation temperature below 30° C.

The aqueous emulsion or dispersion comprising one or more film-forming polymers can be prepared by a person skilled in the art. Some of the polymer emulsions can be obtained from commercially available sources. Some, particularly the radical polymers, can be prepared by emulsion polymerization. Another method of preparing a polymer emulsion is the grinding of large stock into particles in the size range of from 0.001 to 25 microns, and creating a dispersion, in the presence of a dispersant, if necessary.

Emulsion polymerization reactions can produce polymer particle dispersions, polymer droplet emulsions, polymer solutions, or combinations thereof. High polymerization time, monomer concentration, and surfactant concentration tend to correspond with the production of larger particle or droplet size. An increased proportion of particles relative to droplets is generally formed at higher polymer lengths. In the preparation of a polymer emulsion, because of the distribution of polymer lengths, it is not unusual for the polymer to be present in solvated, emulsified and particulate form.

Polymer emulsions/dispersions which can be used in the compositions of the present invention can generally be prepared by emulsion polymerization reaction, with the monomers identified above. The polymerization is typically initiated by free radicals. The monomers and initiators can be added to an agitated, heated mixture of water and surfactants together with a protective colloid such as polyvinyl alcohol. The surfactants form micelles above a critical concentration, and monomers and initiators migrate into the micelles to start the polymerization. The micelles remain discrete through polymerization process, stabilized by the surfactants.

Emulsions or dispersions of polycondensation polymers can be achieved by incorporating monomers with hydrophilic groups or reactive groups. An emulsification or dispersion process separate from polymer formation may be needed.

The polymer and water repellent emulsions or dispersions can be prepared by emulsifying/dispersing in water with surfactants. Heat and homogenization may be needed.

The polymer and water repellent emulsions or dispersions can be prepared by dissolving free radical or polycondensation polymers and water repellents in solvent and emulsifying/dispersing them in water with surfactants, optionally following with solvent stripping. The polymer and water repellent dispersions can also by prepared by grinding, stabilized by surfactants.

The solids content of the aqueous emulsions dispersions according to the present invention can be about 5-70% by weight, and preferably 30-60% by weight, relative to the total weight of the composition.

The composition can comprise a film-forming auxiliary agent, which promotes the formation of a film with the particles of the film-forming polymer. Such film-forming agents will generally lower minimum film formation temperature and can be chosen from compounds known to those skilled in the art such as, for example, plasticizers and coalescence agents.

The water repellent component of the water dispersible water repellent composition of the present invention is selected from the following group: saturated hydrocarbon waxes, silicones, and fluorinated compounds; or mixtures thereof.

The hydrocarbon wax as utilized in the present invention may be of natural or synthetic origin. Examples of natural waxes include petroleum waxes, and in particular, paraffin waxes. Examples of synthetic waxes which can be utilized in the present invention include polymethylene and polyethylene waxes as described more fully below.

The saturated hydrocarbon waxes utilized in the present invention are preferably characterized by the general formula CₙH₂ₙ₊₂ wherein n is from about 18 to about 40. The waxes generally are composed of normal alkanes although they may contain isoalkanes and cycloalkanes. Hydrocarbon waxes containing amounts, preferably only minor, of other elements such as halogens, etc. as substituents, impurities, etc., are within the scope of the present invention. Thus, the term “saturated hydrocarbon” as used with respect to the present invention includes substituted or impure hydrocarbons wherein the extent of the substitution or impurity does not affect its utility in the present invention.

The waxes which are particularly useful in the water dispersible compositions of the present invention are characterized as having a melting point (ASTM D-87) of between about 100° F. to about 160° F. with the lower temperatures being preferred. Preferably the melting point range is from about 100° F. to 140° F.

The paraffin waxes are particularly preferred as the saturated hydrocarbon wax utilized in the water dispersible compositions of the present invention. Paraffin wax is generally understood by one of skill in the art to be a petroleum wax composed of about 40-90 weight percent of normal paraffins, with the remainder being C₁₈-C₃₆ isoalkanes and cycloalkanes. Oil may be present in the paraffin wax. Preferable physical properties of the paraffin waxes which are useful in the water dispersible compositions of the present invention are 1) a melting point range of 114° F.-155° F. and 2) an average molecular weight of 350-420. However, paraffin waxes outside of these ranges can be used.

Polyethylene waxes are low molecular weight polyethylene having wax-like properties. Such polyethylene can be made by known techniques such as, for example, by high pressure polymerization, low pressure (Zeigler-type catalyst) polymerization, or controlled thermal degradation of high molecular weight polyethylene. Polymethylene waxes, also known in the art as Fischer-Tropsch waxes, are produced by polymerizing carbon monoxide under high pressure and over iron catalysts. Low molecular weight synthetic waxes and wax byproducts melting between about 100° F. and 160° F. are generally useful in the present invention.

Silicone compounds present in the composition according to the invention are generally in the form of an aqueous silicone emulsion or aqueous silicone dispersion.

By “aqueous silicone emulsion” is meant an oil-in-water emulsion or in which the silicone compound is dispersed in the form of droplets in a water continuous phase. By “aqueous silicone dispersion” is meant a particulate dispersion in a water continuous phase. The emulsion or dispersion can be stabilized, if necessary by a conventional emulsifying or stabilizing means examples of which are known to those of skill in the art.

The silicone compounds, in emulsion, are preferably polyorganosiloxanes, which can be provided in the form of oils, in particular, volatile or nonvolatile silicone oil, of gums, of resins, of pasty products or of waxes, or their mixtures.

The silicone gums, waxes and resins can be mixed with silicone oils in which they may be dissolved, the mixture being in the form of an oil-in-water emulsion.

Generally, the silicone compounds are polymers comprising repeat units of formula: RₙSiO(_{4-n)/2}. The R substituents present in these repeat units are organic groups and can be identical or different. In addition, the same compound can comprise different repeat units.

The repeat units corresponding to n=2 correspond to a compound having a linear or cyclic structure, the chain of which comprises siloxane bonds. In the case of a linear polymer, units corresponding to n=3 constitute the end groups.

In addition, the silicone compounds can comprise crosslinking units inserted between the repeat units. These crosslinking units correspond to the above formula with n=1 or n=0.

The repeat units in which n=4 correspond to a crosslinked polymer, the end groups of which can be units in which n=1, 2 or 3

The R groups of the above formula can represent in particular alkyl, alkenyl, cycloalkyl, aryl, alkylaryl or hydroxyl groups and can additionally comprise functional groups, such as ethers, amines, carboxyls, hydroxyls, thiols, esters, sulfonates or sulfates.

In the case of the end groups corresponding to n=3, one of the R groups attached to the end silicon can additionally comprise another group, such as an OH group.

Silicone compounds which may be used in the composition of the present invention include nonvolatile silicones, such as, for example, polyorganosiloxanes and preferably polyalkylsiloxanes, polyarylsiloxanes, polyalkylarylsiloxanes, polyethersiloxane copolymers, which may or may not be organomodified, silicone gums, pasty products, waxes and resins, polysiloxanes modified by organofunctional groups, and their mixtures.

They are preferably chosen from polyalkylsiloxanes, linear polydimethylsiloxanes with dimethylsilanol end groups, poly alkylsiloxanes, linear or branched polydimethylmethylphenylsiloxanes and polydimethyidiphenylsiloxanes.

The silicone gums which can be used according to the present invention are preferably polydiorganosiloxanes. They can be used alone or as a mixture in a solvent which can be chosen from volatile silicones, polydimethylsiloxane (PDMS) oils, polyphenylmethylsiloxane (PPMS) oils, isoparaffins, methylene chloride, pentane, dodecane, tridecane, tetradecane or their mixtures.

Silicone waxes, the organopolysiloxane resins (which is defined as in particular crosslinked siloxane systems), the silicones comprising polyethyleneoxy and/or polypropyleneoxy groups, anionic groups of carboxyl type, such as alkylcarboxyl groups, 2-hydroxyalkylsulfonate or 2-hydroxyalkylthiosulfate, and fluorinated groups.

The aqueous emulsion of silicone compounds can be prepared by a person skilled in the art on the basis of his overall knowledge. Some can also be obtained commercially. For example, the above mentioned water repellent compositions can be emulsified or dispersed in water by adding cationic, anionic or non-ionic surfactants, and applying shear with a homogenizer, at a temperature which is, for example, at or above room temperature. In some cases, particulate dispersions of water repellents can be obtained by grinding larger pieces into particles in the range of from 0.001 to 25 microns, and creating a dispersion, in the presence of a dispersant, if necessary.

Preferred organofluorine compounds which can be employed as water-repellent compounds are fluorinated, in particular perfluorinated, hydrocarbons, fluorinated acrylic and methacrylic acid esters, fluoroalkanesulfonic acids and the salts of fluorinated carboxylic acids, in particular those which contain a perfluoroalkyl radical having at least 4 carbon atoms. Examples of preferred monovalent fluorinated carboxylic acid salts are the alkali metal salts of aryl carboxylic acids, such as benzoic acids or naphthoic acids with one or two perfluoroalkyl radicals having preferably 4 to 18 carbon atoms. The organofluorine compounds preferably have a fluorine content of at least 10% by weight.

The compositions disclosed herein comprise a polymer component which comprises a polymer emulsion, dispersion, solution or combination thereof, and, optionally, one or more water repellents. The polymer component can be selected from the polymer or oligomer emulsions or dispersions described above, or combinations thereof. The water repellent can be selected from the waxes, silicones or fluorinated compounds identified above, or combinations thereof.

The combination of polymer emulsion/dispersion and water repellent described in this invention demonstrates a synergistic effect of the polymer component and water repellent. The existence of synergism can be determined using the value of Q_{A}/Qₐ+Q_{B}/Q_{b} as an indicator. If the value Q_{A}/Qₐ+Q_{B}/Q_{b}<1, synergy is exhibited; if Q_{A}/Qₐ+Q_{B}/Q_{b}=1, the polymer and water repellent have an additive effect; if Q_{A}/Qₐ+Q_{B}/Q_{b}>1, the polymer and water repellent have an antagonistic effect,

where: Q_{A} is the concentration of compound A in the mixture where an end point was produced.

Qₐ is the concentration of compound A acting alone where an end point was produced.

Q_{B} is the concentration of compound B in the mixture where an end point was produced.

Q_{b} is the concentration of compound B acting alone where an end point was produced.

Here Qₐ is defined as the concentration of water repellent in weight percentage required to provide 80% of ASE or WEE. Q_{b} is defined as the polymer emulsion concentration in weight percentage required to provide 80% of ASE or WEE. Q_{A} is defined here as the concentration of water repellent in the mixture in weight percentage required to provide 80% of ASE or WEE. Q_{B} is defined here as the polymer emulsion concentration in the mixture in weight percentage required to provide 80% of ASE or WEE. Table 1 shows the synergistic effect of acrylic polymer emulsion and paraffin wax dispersion.

TABLE 1
Synergistic Effect of Acrylic Polymer Emulsion
and Paraffin Wax Dispersion

| | ASE (%) | WEE (%) |
|---|---|---|
| Qₐ | 3 | 5.5 |
| Q_{b} | 47 | 16.6 |
| Q_{A} | 2 | 2.7 |
| Q_{B} | 5 | 5 |
| Q_{A}/Qₐ + Q_{B}/Q_{b} | 0.77 | 0.79 |

Optionally a biocide can be added to the above composition. Water soluble or water insoluble inorganic or organic fungicides, insecticides, moldicides, bactericides, algaecides etc. that can be used with the system are well known to those skilled in the art and include azoles, quaternary ammonium compounds, borate compounds, fluoride compounds disclosed herein and combinations thereof. Insoluble organic biocides can be included as micronized particles in order to enhance their penetration into the wood.

Some non-limiting examples of water insoluble organic biocides are listed below:

Aliphatic Nitrogen Fungicides

butylamine; cymoxanil; dodicin; dodine; guazatine; iminoctadine
   Amide Fungicides
carpropamid; chloraniformethan; cyazofamid; cyflufenamid; diclocymet; ethaboxam; fenoxanil; flumetover; furametpyr; prochloraz; quinazamid; silthiofam; triforine benalaxyl; benalaxyl-M; furalaxyl; metalaxyl; metalaxyl-M; pefurazoate; benzohydroxamic acid; tioxymid; trichlamide; zarilamid; zoxamide; cyclafuramid; furmecyclox dichlofluanid; tolylfluanid benthiavalicarb; iprovalicarb; benalaxyl; benalaxyl-M; boscalid; carboxin; fenhexamid; metalaxyl; metalaxyl-M; metsulfovax; ofurace; oxadixyl; oxycarboxin; pyracarbolid; thifluzamide; tiadinil; benodanil; flutolanil; mebenil; mepronil; salicylanilide; tecloftalam fenfuram; furalaxyl; furcarbanil; methfuroxam flusulfamide
   Antibiotic Fungicides
aureofungin; blasticidin-S; cycloheximide; griseofulvin; kasugamycin; natamycin; polyoxins; polyoxorim; streptomycin; validamycin; azoxystrobin; dimoxystrobin; fluoxastrobin; kresoxim-methyl metominostrobin; orysastrobin; picoxystrobin; pyraclostrobin; trifloxystrobin
   Aromatic Fungicides
biphenyl; chlorodinitronaphthalene chloroneb; chlorothalonil; cresol dicloran; hexachlorobenzene; pentachlorophenol; quintozene; sodium pentachlorophenoxide; tecnazene
   Benzimidazole Fungicides
benomyl carbendazim chlorfenazole cypendazole debacarb fuberidazole mecarbinzid rabenzazole thiabendazole
   Benzimidazole Precursor Fungicides
furophanate thiophanate thiophanate-methyl
   Benzothiazole Fungicides
bentaluron chlobenthiazone TCMTB
   Bridged Diphenyl Fungicides
bithionol dichlorophen diphenylamine
   Carbamate Fungicides
benthiavalicarb furophanate iprovalicarb propamocarb thiophanate thiophanate-methyl benomyl carbendazim cypendazole debacarb mecarbinzid diethofencarb
   Conazole Fungicides
climbazole clotrimazole imazalil oxpoconazole prochloraz triflumizole azaconazole bromuconazole cyproconazole diclobutrazol difenoconazole diniconazole diniconazole-M epoxiconazole etaconazole fenbuconazole fluquinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P
   Dicarboximide Fungicides
famoxadone fluoroimide chlozolinate dichlozoline iprodione isovaledione myclozolin procymidone vinclozolin captafol captan ditalimfos folpet thiochlorfenphim
   Dinitrophenol Fungicides
binapacryl dinobuton dinocap dinocap-4 dinocap-6 dinocton dinopenton dinosulfon dinoterbon DNOC
   Dithiocarbamate Fungicides

azithiram carbamorph cufraneb cuprobam disulfiram ferbam metam nabam tecoram thiram ziram dazomet etem milneb mancopper mancozeb maneb metiram polycarbamate propineb zineb

Imidazole Fungicides

cyazofamid fenamidone fenapanil glyodin iprodione isovaledione pefurazoate triazoxide
   Morpholine Fungicides
aldimorph benzamorf carbamorph dimethomorph dodemorph fenpropimorph flumorph tridemorph
   Organophosphorus Fungicides
ampropylfos ditalimfos edifenphos fosetyl hexylthiofos iprobenfos phosdiphen pyrazophos tolclofos-methyl triamiphos
   Oxathiin Fungicides
carboxin oxycarboxin
   Oxazole Fungicides
chlozolinate dichlozoline drazoxolon famoxadone hymexazol metazoxolon myclozolin oxadixyl vinclozolin
   Pyridine Fungicides
boscalid buthiobate dipyrithione fluazinam pyridinitril pyrifenox pyroxychlor pyroxyfur
   Pyrimidine Fungicides
bupirimate cyprodinil diflumetorim dimethirimol ethirimol fenarimol ferimzone mepanipyrim nuarimol pyrimethanil triarimol
   Pyrrole Fungicides
fenpiclonil fludioxonil fluoroimide
   Quinoline Fungicides
ethoxyquin halacrinate 8-hydroxyquinoline sulfate quinacetol quinoxyfen
   Quinone Fungicides
benquinox chloranil dichlone dithianon
   Quinoxaline Fungicides
chinomethionat chlorquinox thioquinox
   Thiazole Fungicides
ethaboxam etridiazole metsulfovax octhilinone thiabendazole thiadifluor thifluzamide
   Thiocarbamate Fungicides
methasulfocarb prothiocarb
   Thiophene Fungicides
ethaboxam silthiofam
   Triazine Fungicides
anilazine
   Triazole Fungicides
bitertanol fluotrimazole triazbutil
   Urea Fungicides
bentaluron pencycuron quinazamid
   Other Fungicides
acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole

Preferred insecticides which can be mixed with polymer emulsion and water repellents are:

Antibiotic Insecticides

allosamidin; thuringiensin; spinosad; abamectin; doramectin; emamectin; eprinomectin; ivermectin; selamectin; milbemectin; milbemycin oxime; moxidectin
   Botanical Insecticides
anabasine; azadirachtin; d-limonene; nicotine; pyrethrins cinerins; cinerin I; cinerin II; jasmolin I; jasmolin II; pyrethrin I; pyrethrin II; quassia; rotenone; ryania sabadilla
   Carbamate Insecticides
bendiocarb; carbaryl; benfuracarb; carbofuran; carbosulfan; decarbofuran; furathiocarb; dimetan; dimetilan; hyquincarb; pirimicarb; alanycarb; aldicarb; aldoxycarb; butocarboxim; butoxycarboxim; methomyl; nitrilacarb; oxamyl; tazimcarb; thiocarboxime; thiodicarb; thiofanox; allyxycarb; aminocarb; bufencarb; butacarb; carbanolate; cloethocarb; dicresyl; dioxacarb; EMPC; ethiofencarb; fenethacarb; fenobucarb; isoprocarb; methiocarb; metolcarb; mexacarbate; promacyl; promecarb; propoxur; trimethacarb; XMC; xylylcarb
   Dinitrophenol Insecticides
dinex; dinoprop; dinosam; DNOC; cryolite; sodium hexafluorosilicate sulfluramid
   Formamidine Insecticides
amitraz chlordimeform formetanate formparanate
   Fumigant Insecticides
acrylonitrile; carbon disulfide; carbon tetrachloride; chloroform; chloropicrin para-dichlorobenzene; 1,2-dichloropropane; ethyl formate; ethylene dibromide; ethylene dichloride; ethylene oxide; hydrogen cyanide; iodomethane; methyl bromide; methylchloroform; methylene chloride; naphthalene; phosphine; sulfuryl fluoride; tetrachloroethane
   Insect Growth Regulators
bistrifluron; buprofezin; chlorfluazuron; cyromazine; diflubenzuron; flucycloxuron; flufenoxuron; hexaflumuron; lufenuron; novaluron; noviflumuron; penfluron; teflubenzuron; triflumuron; epofenonane; fenoxycarb; hydroprene; kinoprene; methoprene; pyriproxyfen; triprene; juvenile hormone I; juvenile hormone II; juvenile hormone III; chromafenozide; halofenozide; methoxyfenozide; tebufenozide; α-ecdysone; ecdysterone; diofenolan; precocene I; precocene II; precocene III; dicyclanil
   Nereistoxin Analogue Insecticides
bensultap; cartap; thiocyclam; thiosultap; flonicamid; clothianidin; dinotefuran; imidacloprid; thiamethoxam; nitenpyram nithiazine; acetamiprid; imidacloprid; nitenpyram; thiacloprid
   Organochlorine Insecticides
bromo-DDT; camphechlor; DDT; pp′-DDT; ethyl-DDD; HCH; gamma-HCH; lindane; methoxychlor; pentachlorophenol; TDE; aldrin; bromocyclen; chlorbicyclen; chlordane; chlordecone; dieldrin; dilor; endosulfan; endrin; HEOD; heptachlor; HHDN; isobenzan; isodrin; kelevan; mirex
   Organophosphorus Insecticides
bromfenvinfos; chlorfenvinphos; crotoxyphos; dichlorvos; dicrotophos; dimethylvinphos; fospirate; heptenophos; methocrotophos; mevinphos; monocrotophos; naled; naftalofos; phosphamidon; propaphos; schradan; TEPP; tetrachlorvinphos; dioxabenzofos fosmethilan phenthoate; acethion; amiton; cadusafos; chlorethoxyfos; chlormephos; demephion; demephion-O; demephion-S; demeton; demeton-O; demeton-S; demeton-methyl; demeton-O-methyl; demeton-S-methyl; demeton-S-methylsulphon; disulfoton ethion; ethoprophos; IPSP; isothioate; malathion; methacrifos; oxydemeton-methyl; oxydeprofos; oxydisulfoton phorate; sulfotep; terbufos; thiometon amidithion; cyanthoate; dimethoate; ethoate-methyl; formothion mecarbam; omethoate; prothoate; sophamide; vamidothion chlorphoxim; phoxim; phoxim-methyl azamethiphos; coumaphos; coumithoate; dioxathion; endothion; menazon; morphothion; phosalone; pyraclofos; pyridaphenthion; quinothion; dithicrofos; thicrofos; azinphos-ethyl; azinphos-methyl; dialifos; phosmet; isoxathion; zolaprofos; chlorprazophos; pyrazophos; chlorpyrifos; chlorpyrifos-methyl; butathiofos; diazinon; etrimfos; lirimfos; pirimiphos-ethyl; pirimiphos-methyl; primidophos; pyrimitate; tebupirimfos; quinalphos; quinalphos-methyl; athidathion; lythidathion; methidathion; prothidathion; isazofos; triazophos; azothoate; bromophos; bromophos-ethyl; carbophenothion; chlorthiophos; cyanophos; cythioate; dicapthon; dichlofenthion; etaphos; famphur; fenchlorphos; fenitrothion; fensulfothion; fenthion; fenthion-ethyl; heterophos; jodfenphos; mesulfenfos; parathion; parathion-methyl; phenkapton; phosnichlor; profenofos; prothiofos; sulprofos; temephos; trichlormetaphos-3; trifenofos; butonate; trichlorfon; mecarphon; fonofos; trichloronat; cyanofenphos; EPN; leptophos; crufomate; fenamiphos; fosthietan; mephosfolan; phosfolan; pirimetaphos; acephate; isocarbophos; isofenphos; methamidophos; propetamphos; dimefox; mazidox; mipafox
   Oxadiazine Insecticides
indoxacarb
   Phthalimide Insecticides
dialifos; phosmet; tetramethrin
   Pyrazole Insecticides
acetoprole; ethiprole; fipronil; tebufenpyrad; tolfenpyrad; vaniliprole
   Pyrethroid Insecticides
acrinathrin; allethrin; bioallethrin; barthrin; bifenthrin; bioethanomethrin; cyclethrin; cycloprothrin; cyfluthrin; beta-cyfluthrin; cyhalothrin; gamma-cyhalothrin; lamnbda-cyhalothrin; cypermethrin; alpha-cypermethrin; beta-cypermethrin; theta-cypermethrin; zeta-cypermethrin; cyphenothrin; deltamethrin; dimefluthrin; dimethrin; empenthrin; fenfluthrin; fenpirithrin; fenpropathrin; fenvalerate; esfenvalerate; flucythrinate; fluvalinate; tau-fluvalinate; furethrin; imiprothrin; metofluthrin; permethrin; biopermethrin; transpermethrin; phenothrin; prallethrin; profluthrin; pyresmethrin; resmethrin; bioresmethrin; cismethrin; tefluthrin; terallethrin; tetramethrin; tralomethrin; transfluthrin; etofenprox; flufenprox; halfenprox; protrifenbute; silafluofen
   Pyrimidinamine Insecticides
flufenerim; pyrimidifen
   Pyrrole Insecticides
chlorfenapyr
   Tetronic Acid Insecticides
spiromesifen
   Thiourea Insecticides
diafenthiuron
   Urea Insecticides
flucofuron; sulcofuron
   Other Insecticides
closantel; crotamiton; EXD; fenazaflor; fenoxacrim; hydramethylnon; isoprothiolane; malonoben; metoxadiazone; nifluridide; pyridaben; pyridalyl; rafoxanide; triarathene; triazamate
   Preferred Bactericides Include:
bronopol; cresol; dichlorophen; dipyrithione; dodicin; fenaminosulf; formaldehyde; hydrargaphen; 8-hydroxyquinoline sulfate; kasugamycin; nitrapyrin; octhilinone; oxolinic acid; oxytetracycline probenazole; streptomycin tecloftalam thiomersal

Other biocides such as insecticides, mold inhibitors, algaecides, bactericides and the like may also be added to the composition of the present invention.

Non-biocidal products such as colorants, emulsion stabilizers, UV inhibitors, coalescent agents and the like may also be added to the system disclosed herein to further enhance the performance of the system or the appearance and performance of the resulting treated products.

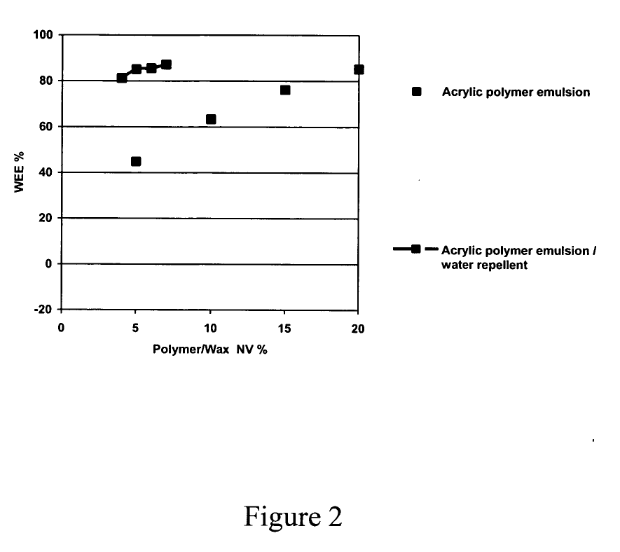

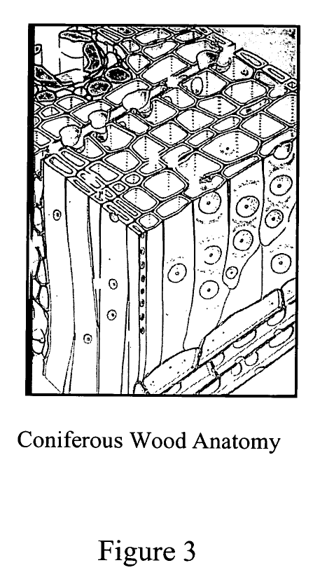

Also important is the penetration of the particles or droplets of the polymer/water repellent formulation into the cellular structure of the wood or other cellulose-based material. As shown in FIG. 2, the primary entry and movement of fluids through wood tissue occurs primarily through the tracheids and border pits. Tracheids have a diameter of about thirty microns. Fluids are transferred between wood cells by means of border pits. The overall diameter of the border pit chambers typically varies from a several microns up to thirty microns, while the diameter of the pit openings (via the microfibrils) typically varies from several hundredths of a micron to several microns. FIG. 3 depicts the border pit structure for coniferous woods.

If the polymer emulsion or dispersion or water repellent used in the formulation disclosed herein has a particle or droplet size in excess of 30 microns, the particles or droplets may be filtered by the surface of the wood and thus may not be uniformly distributed within the cell and cell wall.

Particles of the polymer emulsion or dispersion and the water repellents used in the formulation disclosed herein which exceed 30 microns tend to be filtered by the surface of the wood. A formulation which contains an abundance of such particles may not attain a desired penetration and fluid flow through the wood tissue. In one embodiment, 60 wt % or the polymer and water repellant droplets/particles used in the dispersion formulation disclosed herein can be between 0.001-10 microns. If 80 wt % of such particles are between 0.001-1.0 microns the compositions generally provide a uniform penetration of the chemicals into the wood tissue. The composition has the ability of forming a water repellent film to reduce the evaporation and the adsorption rate of water by the treated substrates. Subsequently the reduction of the gradient of moisture between the surface and internal of the substrate led to the reduced stress and thus improved substrate dimensional stability.

The application of the composition can be dipping, soaking, brushing, spraying, or any other means known to those skilled in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are known to those skilled in the art.

The standard processes are defined as described in AWPA Standard C 1-03 “All Timber Products—Preservative Treatment by Pressure Processes”. In the “Empty Cell” process, prior to the introduction of preservative, materials are subjected to atmospheric air pressure (Lowry) or to higher air pressure (Rueping) of the necessary intensity and duration. In the “Modified Full Cell” process, prior to the introduction of preservative, materials are subjected to a vacuum of less than 77 kPa (22 inch Hg, sea level equivalent). A final vacuum of less than 77 kPa (22 inch Hg, sea level equivalent) shall be used. In the “Full Cell” process, prior to the introduction of preservative or during any period of condition prior to treatment, materials are subjected to a vacuum of less than 77 kPa (22 inch Hg). A final vacuum of less than 77 kPa (22 inch Hg) is used.

The following examples are provided to further describe certain embodiments of the disclosure but are in no way limiting the scope of disclosure.

The reduced swelling and water absorption were tested according to AWPA Standard E4-78 “Standard Method of Testing Water Repellency of Pressure Treated Wood”. The treating fluids of various formulations, were used to treat southern yellow pine E4 wafers (size: 6.4 mm×25 mm×50 mm, or 0.25 in.×1 in.×2 in., in the longitudinal, radial and tangential directions, respectively). The treating fluids were vacuum impregnated into the E4 wafers using a vacuum of not less than 25 inches of Hg followed by submersion of the wafers at atmospheric pressure. The chemical retention of the wafers was calculated from the solution pickups. The treated wafers were allowed to air dry and condition in an exhaust hood for 2 weeks.

The AWPA E-4-78 water immersion test was used to determine the water repellency of the treated wafers. The treated E4 wafers and untreated controls were immersed in water for 30 minutes and the tangential swelling of the wafers and the weight gain were measured using a caliper and a balance specified in the standard. The percentage swell is the tangential length percentage increase after soaking in water for 30 minutes. It can be calculated using an average of three wafers from different parent boards. The water immersion test provides data for the calculation of the anti-swelling efficiency and the water exclusion efficiency according to the following equations:
Anti-swelling efficiency (ASE) is defined as the percentage swell reduced by the treatment versus the untreated controls.

$$ASE ( \% ) = \frac{\begin{matrix}\% Swell of Untreated Control - \\ \% Swell of Treated Sample\end{matrix}}{\% Swell of Untreated Control} \times 100$$

Water exclusion efficiency (WEE) is defined as the water absorption reduction by the treatment in percentage in comparison to untreated controls.

$$WEE ( \% ) = \frac{\begin{matrix}\% Wt Gain of Untreated Control - \\ \% Wt Gain of Treated Sample\end{matrix}}{\% Wt Gain of Untreated Control} \times 100$$

The higher the ASE and WEE values, the more effective the treatment is for the dimensional stabilization wood.

### Example 1

A solution of 5% acrylic polymer emulsion was made with an acrylic polymer emulsion concentrate. The diluted polymer emulsion was then used to treat 0.25″×1″×2″ samples of southern pine sapwood E4 wafers, using an initial vacuum of 28″ Hg for 15 minutes, followed by submerging the E4 wafers in the above treating fluid under the atmosphere condition for 20 minutes. The resulting treated wood was weighed and found to have doubled its weight. The samples were dried and tested for Water Repellency according to AWPA Standard E4-78. The anti-swelling efficiency (ASE) and water exclusion efficiency (WEE) obtained were found to be about 14% and about 45% respectively.

### Example 2

A solution of 10% acrylic polymer emulsion was made with acrylic polymer emulsion concentrate. The above polymer emulsion was then used to treat southern pine sapwood E4 wafers. The dried samples were tested for Water Repellency according to AWPA Standard E4-78. The anti-swelling efficiency (ASE) and water exclusion efficiency (WEE) obtained was found to be about 34% and about 63% respectively.

### Example 3

A solution of 2.5% acrylic polymer emulsion/2.5% paraffin wax dispersion was made with acrylic polymer emulsion and paraffin wax dispersion concentrates. The mixture was mechanically stirred for 5 minutes to achieve a homogeneous emulsion/dispersion. The fluid was then used to treat southern pine sapwood E4 wafers. The dried samples were tested for Water Repellency according to AWPA Standard E4-78. The anti-swelling efficiency (ASE) and water exclusion efficiency (WEE) obtained was found to be about 82% and about 80% respectively.

### Example 4

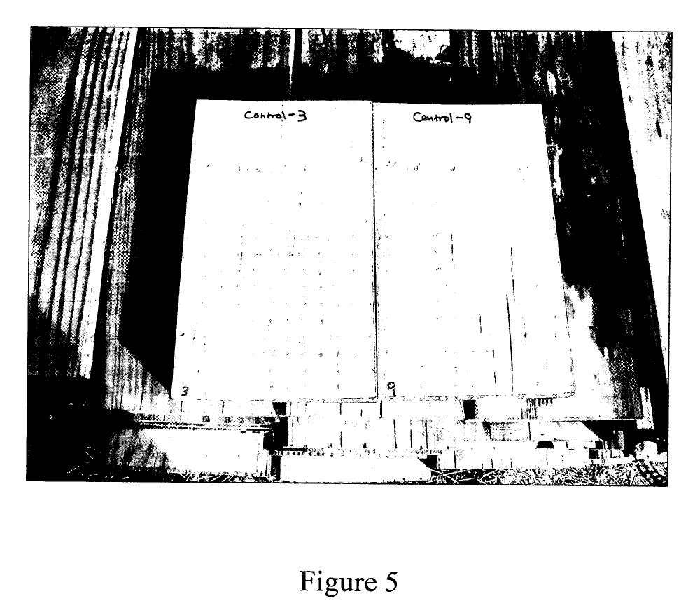

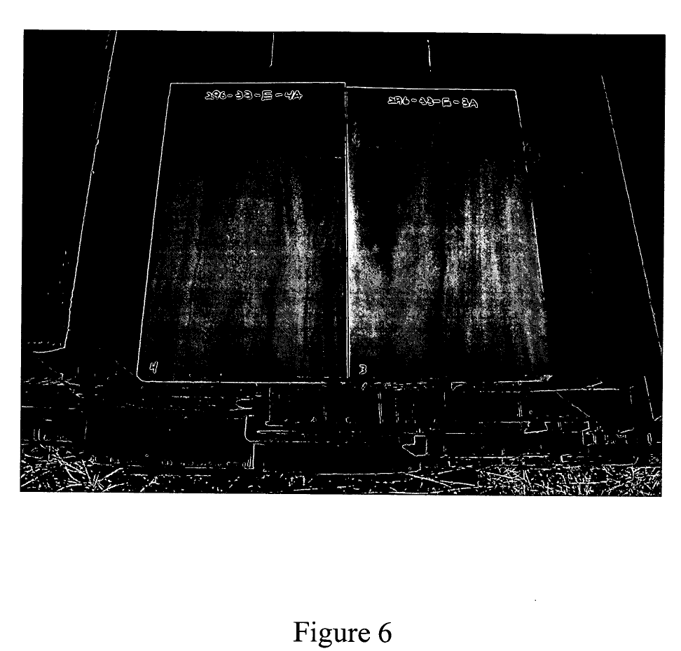

A solution of 5% acrylic polymer emulsion/5% paraffin wax dispersion was made with acrylic polymer emulsion and paraffin wax dispersion concentrates. The mixture was mechanically stirred for 5 minutes to achieve a homogeneous emulsion/dispersion. The fluid was then used to treat 1″×6″×10″ southern pine panels and E4 wafers. The treated samples were allowed to air dry. The dried E4 wafers were tested for Water Repellency according to AWPA Standard E4-78. The anti-swelling efficiency (ASE) and water exclusion efficiency (WEE) obtained was found to be about 87% and about 80% respectively. The test panels were exposed to outdoor weathering for 3 months. FIG. 5 is a photograph of the weathered untreated control after three months exposure which shows checking and staining of the panels. FIG. 6 is a photograph of the weathered panels treated with the above composition. The weathered panel showed no checking or staining after 3 months of outdoor exposure.

### Example 5

A solution of 5% acrylic polymer emulsion/5% paraffin wax dispersion/0.1% oxine copper was made with acrylic polymer emulsion, paraffin wax dispersion and oxine copper dispersion concentrates. The mixture was mechanically stirred for 5 minutes to achieve a homogeneous emulsion/dispersion. The above fluid was then used to treat E4 wafers. The anti-swelling efficiency (ASE) and water exclusion efficiency (WEE) obtained was about 92% and about 84% respectively.

### Example 6

A solution of 2.5% acrylic polymer emulsion/2.5% paraffin wax-polybutene dispersion was made with acrylic polymer emulsion and paraffin wax-polybutene dispersion concentrates. The mixture was mechanically stirred for 5 minutes to achieve a homogeneous emulsion/dispersion. The treated E4 wafers were tested according to AWPA Standard E4-78. The anti-swelling efficiency (ASE) and water exclusion efficiency (WEE) obtained was about 84% and about 85% respectively.

### Example 7

A solution of 5% acrylic polymer emulsion/5% paraffin wax-polybutene dispersion was made with acrylic polymer emulsion and paraffin wax-polybutene dispersion concentrates. The mixture was mechanically stirred for 5 minutes to achieve a homogeneous emulsion/dispersion. The treated E4 wafers were tested according to AWPA Standard E4-78. The anti-swelling efficiency (ASE) and water exclusion efficiency (WEE) obtained was about 87% and about 92% respectively.

### Example 8

A solution of 5% acrylic polymer emulsion/5% paraffin wax-polybutene dispersion/0.1% oxine copper was made with polyester emulsion, paraffin wax dispersion and oxine copper dispersion concentrates. The mixture was mechanically stirred for 5 minutes to achieve a homogeneous emulsion/dispersion. The fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 93% and about 92% respectively.

### Example 9

A solution of 5% PVDC emulsion was made with the dilution of PVDC emulsion concentrate. After mixing for 5 minutes, the fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 1% and about 43% respectively.

### Example 10

A solution of 10% PVDC emulsion was made with the dilution of PVDC emulsion concentrate. After mixing for 5 minutes, the fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 10% and about 53% respectively.

### Example 11

A solution of 5% PVDC polymer emulsion/5% paraffin wax dispersion was made with PVDC polymer emulsion and paraffin wax dispersion concentrates. The mixture was mechanically stirred for 5 minutes to achieve a homogeneous emulsion/dispersion. The fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 91% and about 80% respectively.

### Example 12

A solution of 5% PVDC polymer emulsion/5% paraffin wax-polybutene dispersion was made with PVDC polymer emulsion and paraffin wax-polybutene dispersion concentrates. The mixture was mechanically stirred for 5 minutes to achieve a homogeneous emulsion/dispersion. The fluid was then used to treat southern pine sapwood E4 wafers. The dried samples were tested for Water Repellency according to AWPA Standard E4-78. The anti-swelling efficiency (ASE) and water exclusion efficiency (WEE) obtained was found to be about 87% and about 85% respectively.

### Example 13

A solution of 5% polyester emulsion was made with the dilution of polyester emulsion concentrate. After mixing for 5 minutes, the fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 6% and about 55% respectively.

### Example 14

A solution of 10% polyester emulsion was made with the dilution of polyester emulsion concentrate. After mixing for 5 minutes, the fluid was then used to treat samples of southern pine sapwood E4 wafers. The dried samples were tested for Water Repellency according to AWPA Standard E4-78. The anti-swelling efficiency (ASE) and water exclusion efficiency (WEE) obtained was found to be about 40% and about 72% respectively.

### Example 15

A solution of 5% polyester emulsion/5% paraffin wax dispersion was made with polyester emulsion and paraffin wax dispersion concentrates. The mixture was mechanically stirred for 5 minutes to achieve a homogeneous emulsion/dispersion. The fluid was then used to treat southern pine sapwood E4 wafers. The dried samples were tested for Water Repellency according to AWPA Standard E4-78. The anti-swelling efficiency (ASE) and water exclusion efficiency (WEE) obtained was found to be about 82% and about 79% respectively.

### Example 16

A solution of 5% polyester emulsion/5% paraffin wax-polybutene dispersion was made with polyester emulsion and paraffin wax-polybutene dispersion concentrates. The mixture was mechanically stirred for 5 minutes to achieve a homogeneous emulsion/dispersion. The fluid was then used to treat southern pine sapwood E4 wafers. The dried samples were tested for Water Repellency according to AWPA Standard E4-78. The anti-swelling efficiency (ASE) and water exclusion efficiency (WEE) obtained was found to be about 86% and about 81% respectively.

Although specific embodiments have been described herein, those skilled in the art will recognize that routine modifications can be made without departing from the spirit of the invention.

We claim:

1. A water-based composition comprising:
i) a polymer component wherein the polymer is present in emulsified, dispersed, or solvated form; or combinations thereof; and
ii) a water repellent component wherein the water repellent is present in emulsified and/or dispersed form; said water repellent being selected from the group consisting of saturated hydrocarbon waxes, silicones, fluorinated hydrocarbons, fluorinated acrylic or methacrylic acid esters, fluoroalkanesulfonic acids and salts of fluorinated carboxylic acids.

2. A composition as in claim 1 wherein the polymer component comprises an emulsion and/or dispersion and wherein the size of at least 60 wt % of the dispersion particles and/or emulsion droplets is in the range of from 0.001 to 25 microns; and wherein the water repellent component comprises a dispersion.

3. A composition as in claim 1 wherein the polymer component comprises acrylic, polyester, polyvinylidene chloride or polybutene, and the water repellent component comprises a paraffin wax dispersion.

4. A composition as in claim 1 wherein the polymer component and the water repellent component behave synergistically with respect to ASE or WEE.

5. A composition as in claim 1 wherein the polymer component is a dispersion of particles, and wherein the particles are formed by grinding.

6. A composition as in claim 1 wherein the polymer component is a dispersion of particles, and wherein the particles are formed by emulsion polymerization.

7. A method for improving the dimensional stability of a wood substrate, said method comprising:
i) applying to the wood substrate a composition which comprises:
a) a polymer component wherein the polymer is present in emulsified, dispersed, or solvated form; or combinations thereof; and/or
b) a water repellent component wherein the water repellent is present in emulsified and/or dispersed form; said water repellent being selected from the group consisting of saturated hydrocarbon waxes, silicones, fluorinated hydrocarbons, fluorinated acrylic or methacrylic acid esters, fluoroalkanesulfonic acids and salts of fluorinated carboxylic acids; and
if the wood temperature is less than the minimum film formation temperature of the polymer
ii) raising the temperature of the wood substrate to a temperature which is at or above the minimum film-formation temperature of the polymer;
such that a polymer film is formed on the surface and interior strusture of the substrate after either step i) or step ii).

8. A method as in claim 7 wherein the wood substrate has an ASE which is less than 40% prior to the performance of step i) and an ASE which is greater than 45% after film formation.

9. A method as in claim 7 wherein the polymer component comprises an emulsion and/or dispersion, and wherein the size of at least 60 wt % of the dispersion particles and/or emulsion droplets is in the range of from 0.001 to 25 microns; and wherein the water repellent component comprises a dispersion.

10. A method as in claim 7 wherein the polymer component comprises acrylic, polyester, polyvinylidene chloride or polybutene, and the water repellent component comprises a paraffin wax dispersion.

11. A method as in claim 7 wherein the composition comprises both a polymer component and a water repellent component, and wherein the polymer component and the water repellent component behave synergistically with respect to ASE or WEE.

12. A method as in claim 7 wherein the polymer component is a dispersion of particles, and wherein the particles are formed by grinding.

13. A method as in claim 7 wherein the polymer component is a dispersion of particles, and wherein the particles are formed by emulsion polymerization.

14. A method as in claim 7 wherein applying in step i) comprises impregnation of polymer and/or water repellent particles and/or droplets into said wood substrate.

15. A wood substrate which has undergone the following:
i) treatment with a composition comprising:
a) a polymer component wherein the polymer is present in emulsion, dispersion, or solvated form; or combination thereof; and/or
b) a water repellent component wherein the water repellent is present in emulsified and/or dispersed form; said water repellent being selected from the group consisting of saturated hydrocarbon waxes, silicones, fluorinated hydrocarbons, fluorinated acrylic or methacrylic acid esters, fluoroalkanesulfonic acids and salts of fluorinated carboxylic acids; and
if the wood temperature is less than the minimum film formation temperature of the polymer
ii) raising the temperature of the wood substrate to a temperature which is at or above the minimum film-formation temperature of the polymer;
such that a polymer film is formed on the surface and interior structure of the substrate after either step i) or step ii).

16. A wood substrate as in claim 15 wherein the wood substrate has an ASE which is less than 40% prior to the performance of step i) and an ASE which is greater than 45% after the performance of step ii).

17. A wood substrate as in claim 15 wherein the polymer component comprises an emulsion and/or dispersion, and wherein the size of at least 60 wt % of the dispersion particles and/or emulsion droplets is in the range of from 0.001 to 25 microns; and wherein the water repellent component comprises a dispersion.

18. A wood substrate as in claim 15 wherein the polymer component comprises acrylic, polyester, polyvinylidene chloride or polybutene, and the water repellent component comprises a paraffin wax dispersion.

19. A wood substrate as in claim 15 wherein the polymer component and the water repellent component behave synergistically with respect to ASE or WEE.

20. A wood substrate as in claim 15 wherein the treatment in step i) comprises impregnation of polymer and/or water repellent particles and/or droplets into said wood substrate.
